(19) United States
(12) Patent Application Publication
(10) Pub. No.: US 2026/0291863 A1
(43) Pub. Date: Sep. 24, 2026

(54) APPLICATION TRAFFIC STEERING, SWITCHING, AND SPLITTING (ATSSS) MULTIPATH QUIC STEERING FUNCTIONALITY FOR A FIFTH GENERATION (5G)-RESIDENTIAL GATEWAY (RG)

(71) Applicant: CABLE TELEVISION LABORATORIES, INC., Louisville, CO (US)

(72) Inventor: Rahil Gandotra, Boulder, CO (US)

(73) Assignee: CABLE TELEVISION LABORATORIES, INC., Louisville, CO (US)

(21) Appl. No.: 19/572,309

(22) Filed: Mar. 19, 2026

Related U.S. Application Data
(60) Provisional application No. 63/775,763, filed on Mar. 21, 2025.

(51) Int. Cl. H04L 45/00; H04L 45/302; H04W 28/10

(52) U.S. Cl. CPC H04L 45/38; H04L 45/3065; H04W 28/10

(57) ABSTRACT

A Residential Gateway (RG) uses multipath QUIC (MPQUIC) steering functionalities to leverage multiple network interfaces. An RG sends, to a network node, a protocol data unit (PDU) session request message for a multi-access (MA) PDU session. The PDU session request message includes information indicating RG support for Access Traffic Steering, Switching, and Splitting (ATSSS). Further, the information indicating RG support for ATSSS includes information indicating RG support for MPQUIC. The RG receives a PDU session response message, including ATSSS rules for the MA PDU session and MPQUIC link-specific multipath addresses of the RG. The determines a network access for the MA PDU session from one of a first network access or a second network access. Moreover, the RG transmits and receives data over the determined network access for the MA PDU session based on the MPQUIC link-specific multipath addresses of the RG.

### CROSS-REFERENCE TO RELATED APPLICATION

This application claims the benefit of U.S. Provisional Application No. 63/775,763, filed Mar. 21, 2025, the contents of which are incorporated herein by reference.

### BACKGROUND

Access Traffic Steering, Switching, and Splitting (ATSSS) is a feature in Fifth Generation (5G) networks that allows for more flexible and efficient use of different types of network accesses such as, for example, between a cellular network and a Wi-Fi network. The functions supported by ATSSS include steering, switching, and splitting. In steering, ATSSS can intelligently direct traffic to the most suitable network, whether the network is cellular or Wi-Fi, based on factors like signal strength, network congestion, and application requirements. In switching, if the current access network becomes unstable or congested, ATSSS can seamlessly switch traffic to a different access network without interrupting the user's experience. In splitting, ATSSS can also split traffic across multiple access networks, allowing for better performance and reliability. For example, a high-bandwidth application like video streaming could be split between Wi-Fi and cellular to maximize throughput. User equipment (UE) can support three types of ATSSS steering functionalities – multipath transmission control protocol (TCP) (MPTCP), multipath QUIC (MPQUIC), and ATSSS-lower level (ATSSS-LL).

In wireline 5G-access networks (W-5GANs), a 5G Residential Gateway (RG) is an RG that is capable of connecting to a 5G-Core (5GC) and acting as a UE with respect to the 5GC. The 5G-RG also supports secure element and exchanges N1 signaling with the 5GC. The 5G-RG can support a hybrid access where the 5G-RG can connect to both a next-generation radio access network (NG-RAN) and the W-5GAN. Such a scenario uses the ATSSS described above with the UE replaced by the 5G-RG and non-Third Generation Partnership Project (3GPP) access is referred to as wireline access.

### SUMMARY

Examples and embodiments are provided herein relating to enabling a Residential Gateway (RG) to use multipath QUIC (MPQUIC) steering functionalities to leverage multiple network interfaces such as a cellular network or a wireline network. Such steering functionalities enables the RG to act as a proxy for devices that use the RG and that can only support a single interface. The RG may be a Fifth Generation (5G)-RG, in an example. In another example, the RG may be a Sixth Generation (6G)-RG. In further examples, the RG may be a different type of RG.

In an example, an RG sends, to a network node, a protocol data unit (PDU) session request message for a multi-access (MA) PDU session. The PDU session request message includes information indicating RG support for Access Traffic Steering, Switching, and Splitting (ATSSS). Further, the information indicating RG support for ATSSS includes information indicating RG support for MPQUIC. The RG receives a PDU session response message, including ATSSS rules for the MA PDU session and MPQUIC link-specific multipath addresses of the RG. The determines a network access for the MA PDU session from one of a first network access or a second network access. Moreover, the RG transmits and receives data over the determined network access for the MA PDU session based on the MPQUIC link-specific multipath addresses of the RG.

Additionally or alternatively, the information indicating RG support for MPQUIC includes information indicating RG support for one or more of: MPQUIC-user datagram protocol (UDP), MPQUIC-internet protocol (IP), or MPQUIC-Ethernet (MPQUIC-E). Additionally or alternatively, the PDU session request message is a PDU session establishment request message, and the PDU session response message is a PDU session establishment accept message.

Additionally or alternatively, the PDU session request message is a PDU session modification request message. Additionally or alternatively, the PDU session response message is a PDU session modification acknowledgement/command message.

Additionally or alternatively, the RG activates MPQUIC-based steering functionality for the RG. Additionally or alternatively, the PDU session response message is a PDU session establishment/modification response message. Additionally or alternatively, the PDU session establishment/modification response message further includes MPQUIC proxy information corresponding to the activated MPQUIC-based steering functionality for the RG. Additionally or alternatively, wherein the data is transmitted and received using the activated MPQUIC-based steering functionality for the RG.

Additionally or alternatively, the first network access is a cellular network access, and the second network access is a Wi-Fi network access. Additionally or alternatively, the MPQUIC link-specific multipath addresses of the RG are received from a session management function (SMF), via an access and mobility management function (AMF), and an access network (AN) node.

Additionally or alternatively, the network access for the MA PDU session is determined using MP-QUIC logic. Additionally or alternatively, the MA PDU session response message includes MPQUIC steering information. Additionally or alternatively, a PDU session type, for the MA PDU session, is one of IPv4, IPv6, IPv4v6 or Ethernet.

In at least one aspect, the embodiments and examples disclosed herein provide a method comprising receiving, by a 5G-RG, a request from a device to access data from a data network, where the device supports a single interface; communicating, by the 5G-RG, with a user plane function (UPF) to access the data from the data network; steering, by the 5G-RG, data from the UPF between a first interface and a second interface using an MPQUIC functionality; and transmitting, by the 5G-RG, the data to the device.

In another aspect, the examples herein provide that the first interface comprises a cellular network and the second interface comprises a wireline network.

In another aspect, the examples herein provide that the single interface comprises a Wi-Fi network. The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1 is an illustration of an example device;

FIG. 2 illustrates an example communication system;

FIG. 3 illustrates an example of a functional split between a next generation radio access network (NG-RAN) and Fifth Generation (5G) core (5GC);

FIG. 4 illustrates an example of a protocol stack for a user plane and a control plane;

FIG. 5 illustrates an example of a conventional architecture for supporting Access Traffic Steering, Switching, and Splitting (ATSSS) for a user equipment (UE);

FIG. 6 illustrates an example of an architecture for supporting ATSSS for a 5G-residential gateway (RG);

FIG. 7 illustrates an example of use of the 5G-RG as a proxy for a device;

FIG. 8 illustrates an example of an architecture for supporting multipath QUIC (MPQUIC)-based ATSSS steering functionalities within an RG for access over an NG-RAN or wireline 5G-access network (W-5GAN);

FIG. 9 illustrates an example of a procedure to support MPQUIC steering functionality for an RG;

FIG. 10 illustrates an example of architecture for supporting MPQUIC-based ATSSS steering functionalities within an RG for access over an evolved universal terrestrial radio access (E-UTRAN) and W-5GAN;

FIG. 11 illustrates an example of architecture for supporting MPQUIC-based ATSSS steering functionalities within an RG for access over a Sixth Generation (6G) RAN and W-5GAN;

FIG. 12 illustrates an example of architecture for supporting MPQUIC-based ATSSS steering functionalities within an RG for access over an NG-RAN and wireline 6G-access network (W-6GAN); and

FIG. 13 illustrates an example of architecture for supporting MPQUIC-based ATSSS steering functionalities within an RG for access over an 6G-RAN and W-6GAN.

### DETAILED DESCRIPTION

Access Traffic Steering, Switching and Splitting (ATSSS) is a Third Generation Partnership Project (3GPP)-defined capability introduced in Fifth Generation (5G) procedures to enable a user equipment (UE) to simultaneously utilize multiple access networks—most commonly 3GPP access (e.g., new radio (NR)) and non-3GPP access (e.g., Wi-Fi)—under the control of the 5G Core. ATSSS allows the network to influence how Internet Protocol (IP) traffic flows are distributed across available accesses based on operator policy, service requirements, and real-time access conditions. The primary objectives of ATSSS are to improve user experience through higher throughput, enhanced reliability, and seamless mobility, while allowing operators to optimize resource utilization across heterogeneous access technologies. ATSSS policies are provisioned by the network (via the session management function (SMF) and policy control function (PCF)) and enforced at the UE and user plane function (UPF), enabling coordinated traffic handling without requiring application-level awareness in the baseline model.

3GPP specifies multiple ATSSS steering mechanisms that differ in the protocol layer at which traffic aggregation and steering are realized. ATSSS-LL (Lower Layer) steering operates below the transport layer and enables per-packet or per-flow steering across accesses without modifying the transport protocol; this approach offers transparency to applications but is limited in its ability to perform true multipath congestion control. ATSSS using Multipath transmission control protocol (TCP) (MPTCP) extends the TCP transport to support multiple subflows over different accesses, allowing dynamic traffic splitting and resilience to path failures while remaining compatible with TCP-based applications.

QUIC is gaining traction, and both handset vendors and network equipment vendors are interested in QUIC-based proxy solutions and enabling use of the ATSSS Multipath MPQUIC proxy functionality for residential gateways. For example, recently, ATSSS using QUIC (MPQUIC) has emerged as a transport-layer alternative that builds multipath support on top of QUIC over user datagram protocol (UDP), providing improved connection establishment latency, native encryption, and finer-grained stream-level steering. MPQUIC is particularly attractive for 5G and fixed–mobile convergence scenarios due to its flexibility, reduced head-of-line blocking, and better alignment with modern application traffic patterns, making it a key enabler for advanced ATSSS functionality in next-generation UEs and residential gateways (RGs).

Under past procedures, certain ATSSS functionalities are not supported when a 5G-RG supports hybrid access and can connect to both a next-generation radio access network (NG-RAN) and a wireline 5G-Access Network (W-5GAN). More specifically, conventional 5G-RG supports MPTCP and ATSSS-LL steering functionalities, but does not support the MPQUIC steering functionality. Thus, it is desirable to extend the support of the MPQUIC steering functionalities including MPQUIC-UDP, MPQUIC-IP, and MPQUIC-Ethernet (MPQUIC-E) to the 5G-RG.

Examples and embodiments are provided herein relating to enabling a 5G Residential Gateway (5G-RG) to use MPQUIC steering functionalities to leverage multiple network interfaces such as a cellular network or a wireline network. Such steering functionalities enables the 5G-RG to act as a proxy for devices that use the 5G-RG and that can only support a single interface.

As used herein, the phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X1-Xn, Y1-Ym, and Z1-Zo, the phrase is intended to refer to a single element selected from X, Y, and Z, a combination of elements selected from the same class (e.g., X1 and X2) as well as a combination of elements selected from two or more classes (e.g., Y1 and Zo).

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

Numerous additional features and advantages of the embodiment and examples provided herein will become apparent to those skilled in the art upon consideration of the descriptions provided herein below.

The underlying principle of a communication system is to enable one or more devices to communicate with one or more other devices. At a basic level, each device may need some basic components to operate. Any device referenced herein, including the hardware (e.g., virtual or physical) to run a function, software entity, application, or the like, may be understood to have at least one or more of the following components (e.g., where there may be one or more of each component): a processor, a transceiver (e.g., which may or may not be integrated with the processor), an input (e.g., microphone, keyboard, mouse, etc.), an output (e.g., port for outputting display signals, a display, a touch screen, a printer, etc.), a power source, a positioning chip (e.g., global positioning system (GPS), GLONASS, etc., which may or may not be integrated with the processor and/or transceiver), button (e.g., for controlling the specific function of one or more aspects of the device). These components may be operably connected to one another, meaning that there may be a direct connection or an indirect connection to one or more of the components.

A UE may be interchangeable with a station (STA), a mobile station, a fixed or mobile subscriber unit, a subscription-based unit, a pager, a cellular telephone, a personal digital assistant (PDA), a smartphone, a laptop, a netbook, a computer, a server, a functional entity (e.g., virtual and/or physical) a wireless sensor, a hotspot or Mi-Fi device, an Internet of Things (IoT) device, a watch or other wearable, a head-mounted display (HMD), a vehicle, a drone, or the like.

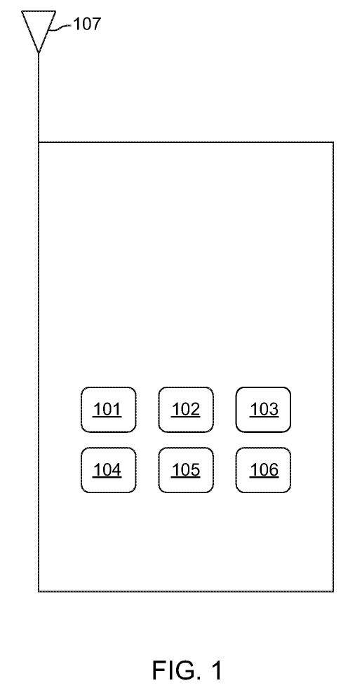

FIG. 1 is an illustration of an example device. In one case, the device may be a UE suited for mobile operation. In this example, the UE may have a processor 101, a transceiver 102, a touchscreen 103, a power source 104 (e.g., a battery), a GPS 105, one or more other components 106 (e.g., as described herein), and/or an antenna 107.

Generally, a processor may be any kind of processor, such as a processor capable of carrying out one or more of the techniques described herein. A transceiver may be configured to transmit and receive signals. In one case, there may be a separate receiver and transmitter. A transceiver may be connected to one or more antennas (e.g., MIMO technology). A transceiver may be configured to transmit RF signals. In one case, a transceiver may be configured to transmit light signals (e.g., IR, UV, laser, etc.). A transceiver may be configured to send/receive more than one type of RF signal (e.g., different radio access technologies for one transceiver, or multiple transceivers each dedicated to a specific radio access technology). A transceiver may be configured to modulate signals for transmission, and demodulate signals for reception. The UE may be capable of full duplex operation, where there is transmission and reception of some or all signals may be concurrent and/or simultaneous, for example, different timing/spacing for uplink (UL) or downlink (DL).

Different radio access technologies may be used with one or more transceivers (e.g., 802.11, WCDMA, CDMA2000, GSM, LTE, LTE-A, LTE-A Pro, NR etc.).

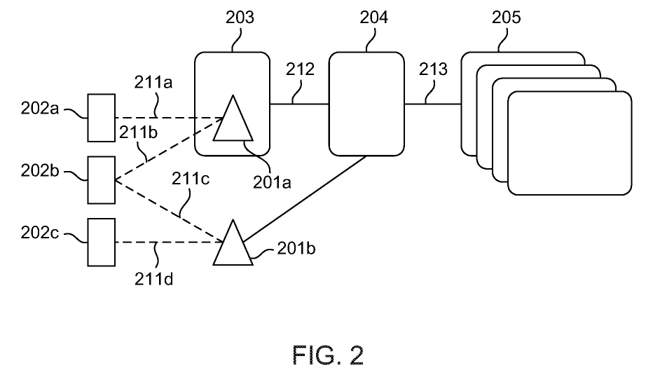

FIG. 2 illustrates an example communication system. This example may be used to illustrate multiple wireless protocols. For all wireless protocols, there may be mobile or stationary devices (e.g., 202a, 202b, 202c, such as a UE) that connect to a base station device 201a and/or 201b. In one case, this may enable a mobile device to connect to a service (e.g., a remote server) or data network (e.g., internet).

In one case, the base stations (201a, 201b) may be equivalent to, and/or interchangeable with, a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, transmission receive point (TRP), network (NW), RP (reception point), RRH (radio remote head), DA (distributed antenna), BS (base station), a sector (of a BS), and a cell (e.g., a geographical cell area served by a BS). Each base station may be representative of more than one base station (e.g., multiple transmission reception points).

A base station may be a network node. Other network nodes may be located in a network, including the core network. A network node may communicate over a wired connection, over a wireless connection, or over both. A network node may include a processor and a communications interface. The communications interface may be or may include a network interface card (NIC), in an example. A network node may be or may include a network function (NF).

Generally, a communication system may use a combination of wired and wireless connections at different points in the system. One or more wireless technologies (e.g., channel access methods), may include code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

A base station may be configured to transmit and/or receive wireless signals on one or more carrier frequencies, which may be referred to as a cell (not shown). A base station (201a, 201b) may communicate with one or more UEs (202a, 202b, 202c) over an air interface (211a, 211b, 211c, 211d).

In one case, one or more base stations may implement LTE radio access and NR radio access together, for instance using dual connectivity (DC) approach. Therefore, the system (e.g., and perhaps one or more UEs) may implement multiple types of radio access technologies that uses more than one type of base station (e.g., an eNB and a gNB).

In one case, the communication system may include a radio access network (RAN) 203, a core network (CN) 204, and one or more other elements represented by 205 (e.g., public switched telephone network (PSTN), the Internet, and other networks or the like).

In one scenario using FIG. 2 as an illustration, a RAN 203 may be in communication with a CN 204. The base station 201a may be an eNB, and the access technology may be based on evolved universal terrestrial radio access (E-UTRA) (e.g., long-term evolution (LTE), etc.). The communication system may handle data transmission from the UE 202a. The data may have varying quality of service (QoS) requirements, such as differing throughput requirements, latency requirements, error tolerance requirements, reliability requirements, data throughput requirements, mobility requirements, and the like. The CN 204 may provide call control, billing services, mobile location-based services, pre-paid calling, Internet connectivity, video distribution, etc., and/or perform high-level security functions, such as user authentication. Although not shown, the RAN 203 and/or the CN 204 may be in direct or indirect communication with other RANs that employ the same radio access technology (RAT) as the RAN 203 or a different RAT. For example, in addition to being connected to the RAN 203, which may be utilizing a NR radio access technology, the CN 204 may also be in communication with another RAN (not shown) employing another radio access technology (e.g., E-UTRA, WiFi, etc.). Each of the eNBs may be associated with a particular cell (not shown) and may be configured to handle radio resource management decisions, handover decisions, scheduling of users in the UL and/or DL, and the like. Each eNB may communicate with one another over an X2 interface (not shown).

In one scenario using FIG. 2 as an illustration, the RAN 203 and the CN 204 may employ NR radio access technologies and related protocols. The base station may be a gNB 201. The gNB(s) may implement carrier aggregation technology, where multiple component carriers may be transmitted to the UE 202a. A subset of these component carriers may be on unlicensed spectrum while the remaining component carriers may be on licensed spectrum. The UE(s) may communicate with the gNB(s) using transmissions associated with a scalable numerology (e.g., subcarrier spacing, etc.). For example, the OFDM symbol spacing and/or OFDM subcarrier spacing may vary for different transmissions, different cells, and/or different portions of the wireless transmission spectrum. The UE(s) may communicate with gNB(s) using subframe or transmission time intervals (TTIs) of various or scalable lengths (e.g., containing a varying number of OFDM symbols and/or lasting varying lengths of absolute time). The gNB(s) may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards a UPF, routing of control plane information towards access and mobility management function (AMF), and the like. The gNB(s) may communicate with one another over an Xn interface.

Not shown (e.g., but still possibly part of one or more example scenarios described herein), the CN may include one or more AMFs, one or more UPFs, one or more SMFs, and/or one or more Data Networks (DNs). In one case, the aforementioned elements may be owned and/or operated by an entity other than the CN operator.

In one scenario using FIG. 2 as an illustration, an Internet 205 may include a global system of interconnected computer networks and devices that use common communication protocols, such as the TCP, UDP and/or the Internet protocol (IP) in the TCP/IP internet protocol suite.

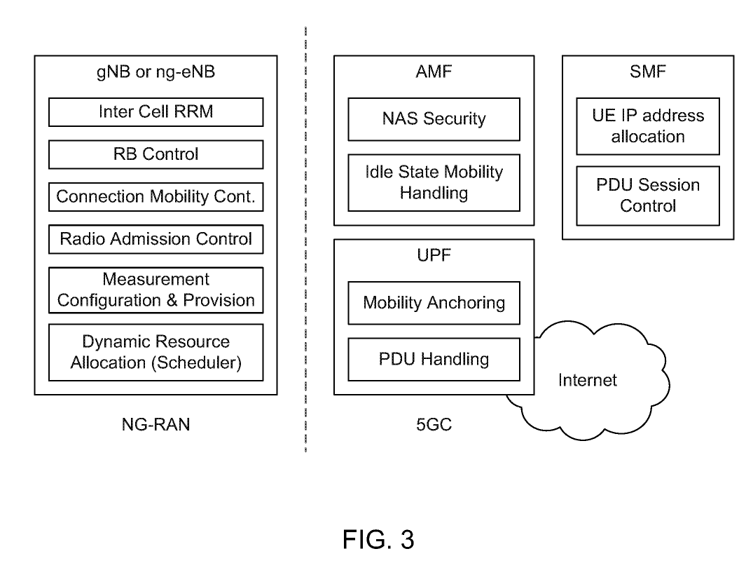

FIG. 3 illustrates an example of a functional split between the next generation radio access network (NG-RAN) and Fifth Generation (5G) core (5GC). The AMF may be connected to one or more gNB the RAN via an N2 interface and may serve as a control node. For example, the AMF may be responsible for authenticating a UE’s support for network slicing (e.g., handling of different protocol data unit (PDU) sessions with different requirements), selecting a particular SMF, management of the registration area, termination of non-access stratum (NAS) signaling, mobility management, and the like. Network slicing may be used by the AMF in order to customize CN support for one or more UEs based on the types of services being utilized by the respective UE. For example, different network slices may be established for different use cases such as services relying on ultra-reliable low latency (URLLC) access, services relying on enhanced massive mobile broadband (eMBB) access, services for MTC access, and the like. The AMF may provide a control plane function for switching between the RAN and other RANs that employ other radio technologies (e.g., as described herein). The SMF may be connected to an AMF in the CN via an N11 interface. The SMF may also be connected to a UPF in the CN via an N4 interface. The SMF may select and control the UPF and configure the routing of traffic through the UPF. The SMF may perform other functions, such as managing and allocating UE IP address, managing PDU sessions, controlling policy enforcement and QoS, providing DL data notifications, and the like. A PDU session type may be IP-based, non-IP based, Ethernet-based, and the like. The UPF may be connected to one or more gNB in the RAN via an N3 interface, which may provide a UE with access to packet-switched networks, such as the Internet, to facilitate communications between one or more UEs and IP-enabled devices. The UPF may perform other functions, such as routing and forwarding packets, enforcing user plane policies, supporting multi-homed PDU sessions, handling user plane QoS, buffering DL packets, providing mobility anchoring, and the like. The CN may facilitate communications with other networks. For example, the CN may provide a UE with access to the other networks 212, which may include other wired and/or wireless networks that are owned and/or operated by other service providers. In one example, the UEs may be connected to a local DN through a UPF via an N3 interface to the UPF and an N6 interface between the UPF and the DN. As discussed herein, a NR RAN may be called an NG-RAN and a NR CN may be called a 5GC.

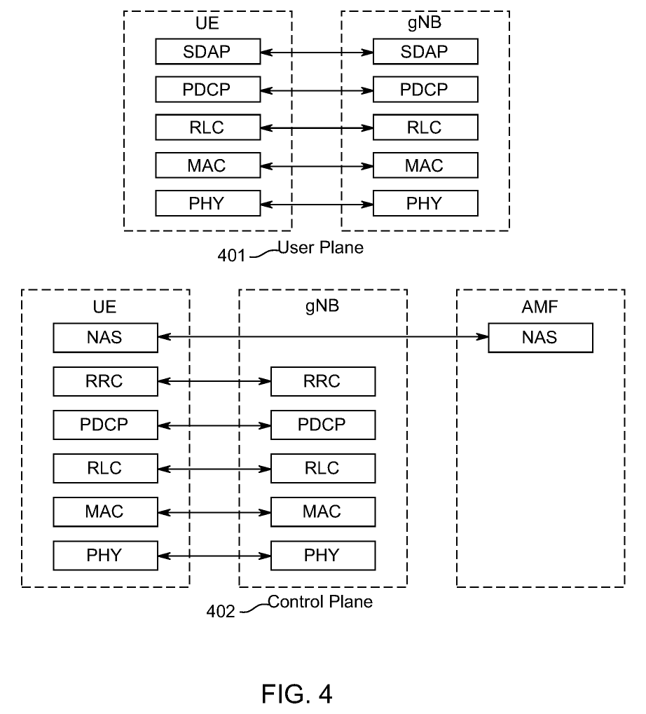

FIG. 4 illustrates an example of a protocol stack for the user plane and control plane. The user plane protocol stack 401 and the control plane stack 402 are shown in an example in FIG. 4. A higher layer may refer to one or more layers in a protocol stack, or a specific sublayer within the protocol stack. The protocol stack may comprise of one or more layers in a UE or a network node (e.g., eNB, gNB, other functional entity, etc.), where each layer may have one or more sublayers. Each layer/sublayer may be responsible for one or more functions. Each layer/sublayer may communicate with one or more of the other layers/sublayers, directly or indirectly. In some cases, these layers may be numbered, such as Layer 1, Layer 2, and Layer 3. For example, Layer 3 may comprise of one or more of the following: NAS, Internet Protocol (IP), and/or Radio Resource Control (RRC). For example, Layer 2 may comprise of one or more of the following: Packet Data Convergence Control (PDCP), Radio Link Control (RLC), and/or Medium Access Control (MAC). For example, Layer 3 may comprise of physical (PHY) layer type operations. The greater the number of the layer, the higher it is relative to other layers (e.g., Layer 3 is higher than Layer 1). In some cases, the aforementioned examples may be called layers/sublayers themselves irrespective of layer number, and may be referred to as a higher layer as described herein. For example, from highest to lowest, a higher layer may refer to one or more of the following layers/sublayers: a NAS layer, a RRC layer, a PDCP layer, a RLC layer, a MAC layer, and/or a PHY layer. Any reference herein to a higher layer in conjunction with a process, device, or system will refer to a layer that is higher than the layer of the process, device, or system. In some cases, reference to a higher layer herein may refer to a function or operation performed by one or more layers described herein. In some cases, reference to a high layer herein may refer to information that is sent or received by one or more layers described herein. In some cases, reference to a higher layer herein may refer to a configuration that is sent and/or received by one or more layers described herein.

The examples provided herein are based on the Third Generation Partnership Project (3GPP) 5G architecture and the procedures associated with the 5GC. One with ordinary skills in the art may envision other technologies being used and the same concepts may apply. Examples of other technologies may be Fourth Generation (4G), CBRS, cdma2000, Sixth Generation (6G), 802.11, Wi-Fi, wireline (Ethernet), and beyond. The examples provided herein should not limit the scope of the methods.

The 3GPP standards support the access to the 5GC via a wireline access network (AN). A wireline 5G access network (W-5GAN) is a wireline AN that may connect to a 5GC. For example, devices in a home local access network (LAN), such as a residential gateway (RG), may connect to the 5GC via a Wireline Access Gateway Function (W-AGF) in the W-5GAN. The W-AGF is a network function that may interface with the 5GC Control Plane (CP) and the 5GC User Plane (UP) functions, via N2 and N3 interfaces, respectively. In the example of a home LAN, the W-AGF may provide connectivity towards the 5GC to the home LAN devices using one or more N2 and N3 interfaces with the 5GC.

An RG is a device providing, for example, voice, data, broadcast video, video on demand, etc. to other devices in specific locations referred to as customer premises. In this example, an RG may have one or more processors, such as Central Processing Units (CPUs), Graphical Process Units (GPUs), Front End Processors (FEPs), Communication Processors (CPs), Field Programmable Gate Arrays (FPGAs), Vision Processing Units (VPU), Quantum Processing Units (QPUs), Associative Processing Units (APUs), and Tensor Processing Units (TPUs); a baseband radio; one or more transceivers; one or more antennas; storage, such as HDD, SSD, NVM, RAM, ROM, memory, cache; memory controller(s), a touchscreen, and a power source. The RG may also have one or more of its functions virtualized.

An RG may contain functionality that enables devices behind it to also connect with the 5GC and obtain 5G services. The devices behind the RG may be of different types, such as 3GPP-capable devices (e.g., UEs), authenticable non-3GPP (AUN3) devices, non-authenticable non-3GPP (NAUN3) devices, or non-5G-Capable over WLAN (N5CW) devices. An RG may be 5G-capable, in which case it is referred to as a 5G-RG, or it may not be 5G- capable, in which case it is referred to as a Fixed Network RG (FN-RG). The 5G-RG may play the role of a UE.

A 5G-RG is an RG capable of connecting to the 5GC and playing the role of a UE with regard to the 5GC. The 5G-RG supports secure elements and exchanges N1 signaling with the 5GC. The 5G-RG can be either a 5G-broadband RG (5G-BRG) or a 5G-cable RG (5G-CRG).

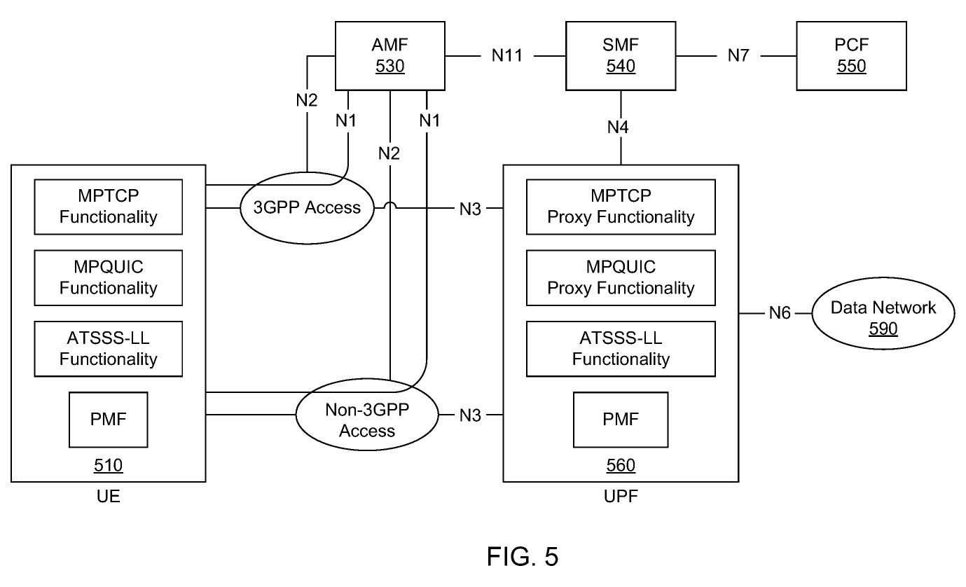

FIG. 5 illustrates an example of a conventional architecture for supporting ATSSS for a UE. As previously described, ATSSS is a feature in 5G networks that allows for more flexible and efficient use of different types of network accesses by a UE 510 such as, for example, between a cellular network and a Wi-Fi network. The UE 510 may be, for example, a mobile device that can be used on the cellular network and/or the Wi-Fi network. As shown in FIG. 5, the UE 510 includes an MPTCP functionality, an MPQUIC functionality, an ATSSS-LL functionality, and a Performance Measurement Function (PMF).

The architecture also includes an AMF 530 that manages a connection or mobility management and forwards session management requirements to an SMF 540. The SMF 540 then manages session context with a UPF 560. The AMF 530 can support both 3GPP access networks and non-3GPP access networks via an N2 interface.

The architecture also includes a PCF 550 which interacts with the SMF 540. The PCF 550 manages and controls policies that regulate aspects of the network such as, for example, security, authentication, network resource allocation, etc.

The UPF 560 acts as interconnection point between the 5G infrastructure and the data network 590. More specifically, the UPF 560 connects to the 3GPP Access or Non-3GPP Access node over an N3 interface, the SMF 540 over an N4 interface, and the data network 590 over an N6 interface. The UPF 560 also includes an MPTCP proxy functionality, an MPQUIC proxy functionality, an ATSSS-LL functionality, and PMF.

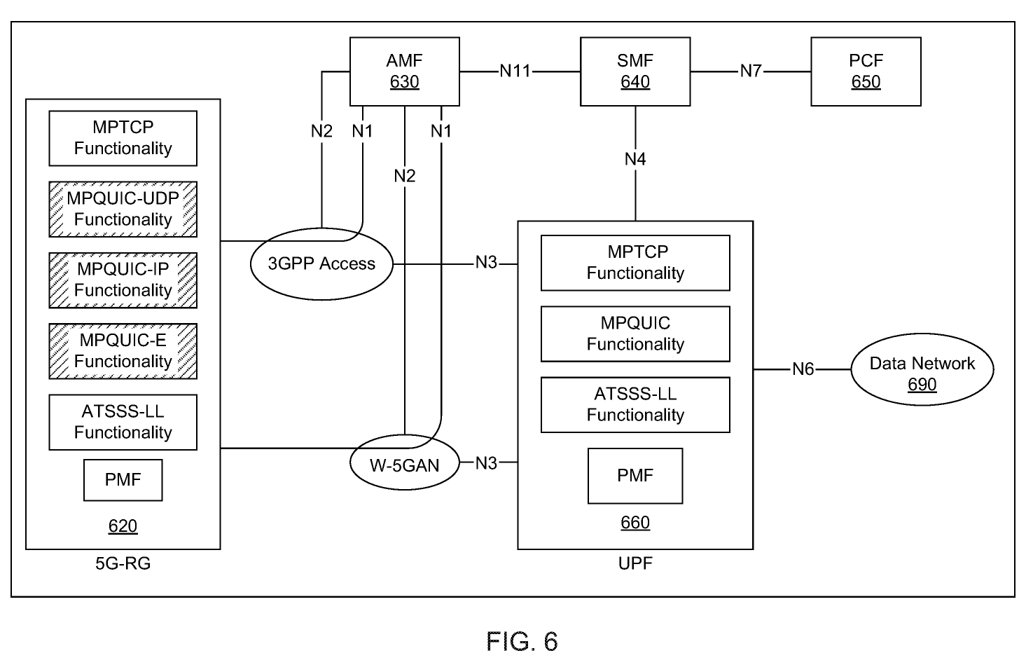

FIG. 6 illustrates an example of an architecture for supporting ATSSS for a 5G-RG. A 5G-RG 620 provides a connection between home networked equipment within, for example, a home or small business, to the 5GC network and then to the data network 690. For example, the 5G-RG 620 may connect with a home device such as a laptop computer.

The architecture in FIG. 6 is generally similar to the architecture described above in FIG. 5 except that the UE is a 5G-RG 620 and the non-3GPP access is W-5GAN. As in the example in FIG. 5, an example in FIG. 6 includes an AMF 630, SMF 640, PCF 650, and UPF 660. As shown in FIG. 6, the 5G-RG 520 includes MPQUIC steering functionality such as a MPQUIC-UDP steering functionality, an MPQUIC-IP steering functionality, and an MPQUIC-E steering functionality in addition to the MPTCP steering functionality, the ATSSS-LL steering functionality, and the PMF. By extending the MPQUIC steering functionalities to the 5G-RG 620, the 5G-RG 620 can be beneficially used as a proxy for devices with only one interface, as the 5G-RG 620 can steer data between at least two interfaces, as will be described below.

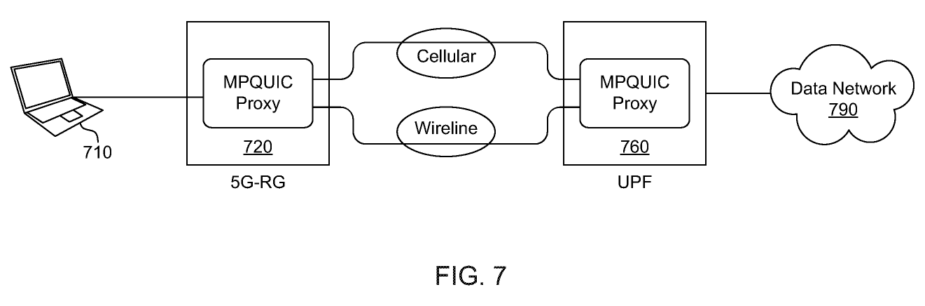

FIG. 7 illustrates an example use of the 5G-RG as a proxy for a device. A device 710 shown in an example in FIG. 7 may be, for example, a laptop computer that can support one interface such as Wi-Fi. As shown, the device 710 communicates with the 5G-RG 720 which acts as a MPQUIC proxy and can switch between a first interface such as a cellular network and a second interface such as a wireline network to access the UPF 760. The UPF 760, which also acts as a MPQUIC proxy, then communicates with the data network 790 to receive data to transmit to the 5G-RG 720, which then transmits the data to the device 710. With the 5G-RG 720 acting as the MPQUIC proxy, the device 710 can connect to the data network 790 via more than one interface (e.g., the cellular network and/or the wireline network), thereby increasing a speed of the device’s network connection. Thus, a device 710 that only supports one interface can benefit from the steering capabilities of the 5G-RG 720 without having steering capabilities itself.

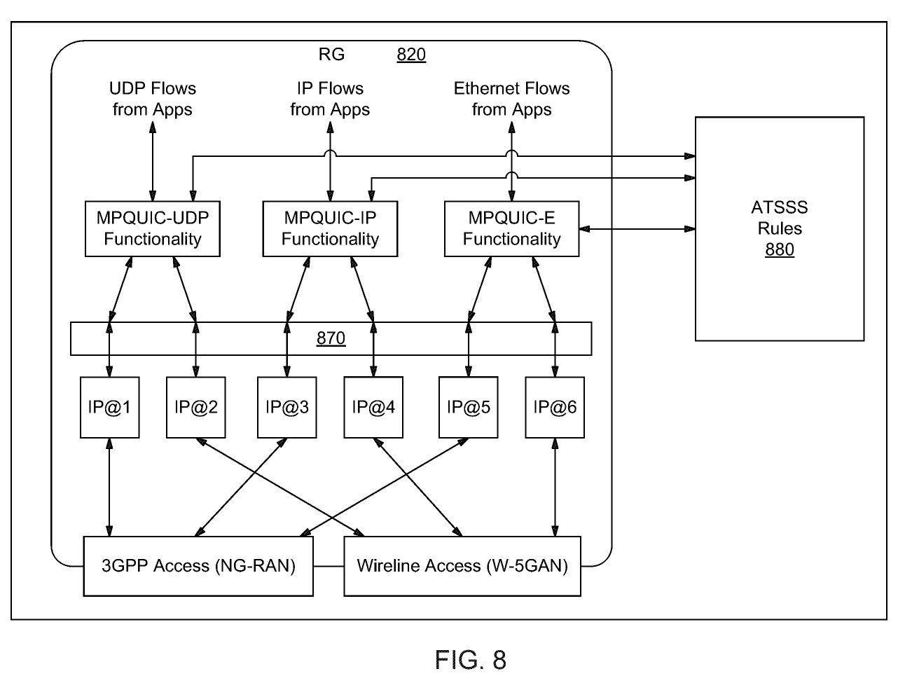

FIG. 8 illustrates an example of architecture for supporting MPQUIC-based ATSSS steering functionalities within an RG for access over an NG-RAN and W-5GAN. Examples in FIG. 8 include highlighting how traffic from applications can be handled and distributed across multiple accesses under network-provided ATSSS rules 880. Different forms of application traffic—UDP flows, IP flows, and Ethernet flows—can be supported. Correspondingly, an RG 820 supports multiple MPQUIC steering instantiations: MPQUIC-UDP functionality when an MA PDU Session type is IPv4, IPv6, or IPv4v6, MPQUIC-IP functionality when the MA PDU Session type is IPv4, IPv6, or IPv4v6, and MPQUIC-Ethernet functionality when the MA PDU Session type is Ethernet. Further, based on the ATSSS rules 880, if the application traffic is in the form of UDP flows, then the RG 820 instantiates the MPQUIC-UDP functionality. Additionally or alternatively, if the application traffic is in the form of IP flows, then the RG 820 instantiates the MPQUIC-IP functionality. Additionally or alternatively, if the application traffic is in the form of Ethernet flows, then the RG 820 instantiates the MPQUIC-Ethernet functionality. Each of these functional blocks represents a distinct steering mode in which the RG 820 encapsulates or maps incoming traffic into MPQUIC connections suitable for multipath operation.

Below the MPQUIC functional blocks, the example in FIG. 8 shows a common steering and forwarding layer 870 that manages multiple IP anchor points or addresses (labeled IP@1 through IP@6). The MPQUIC functional blocks may access these IP anchor points or addresses via one or more other layers, which may include one or more layers used by one or more of a kernel, operating system (OS), NIC, and so forth, in an example. These IP addresses represent different logical paths or interfaces that can be bound to either a 3GPP access (NG-RAN) or a non-3GPP wireline access (Wireline 5G Access Network (W-5GAN)). The crisscrossing arrows from the IP addresses indicate that individual MPQUIC connections can simultaneously utilize multiple IP addresses spanning both access types, enabling true multipath operation across heterogeneous networks. The selection, activation, and traffic distribution across these paths are governed by ATSSS rules 880 provided to the RG 820 by the cellular Core.

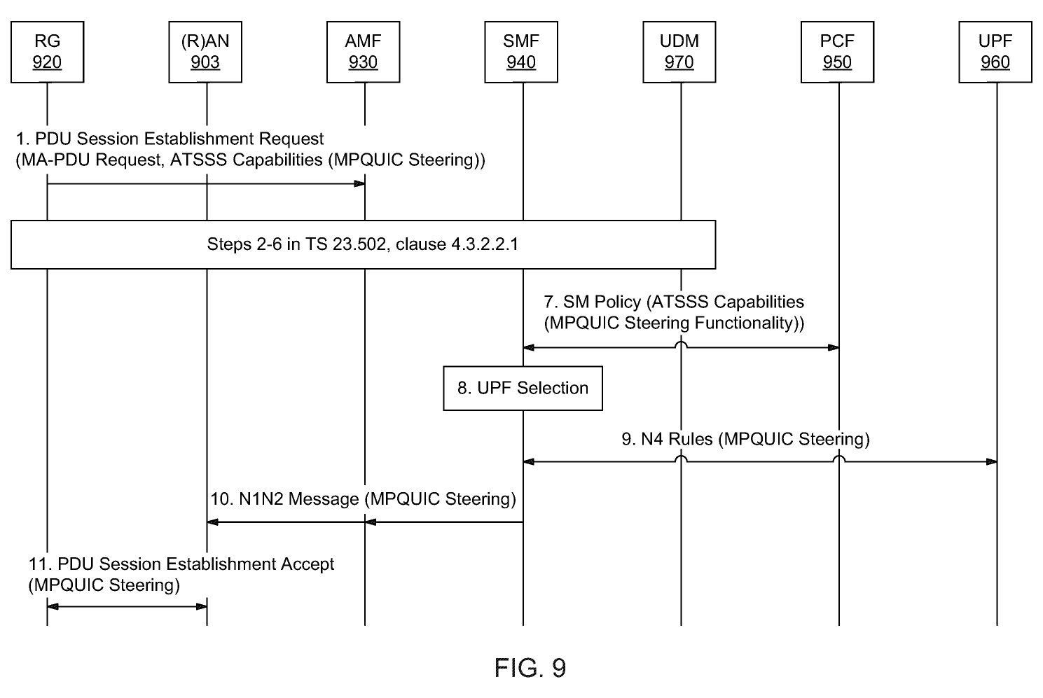

FIG. 9 illustrates an example of a procedure to support MPQUIC steering functionality for an RG. As shown in an example in FIG. 9, in a step 1, during the PDU Session Establishment/Modification Request, an RG 920 indicates ATSSS capability support (part of the UE 5GSM Core Network Capability), explicitly including support for MP-QUIC-based steering. In examples involving 5G access, the RG may be a 5G-RG. This indication of support for MP-QUIC-based steering may include any one, or a combination of: MPQUIC-UDP, MPQUIC-IP, or MPQUIC-E. For example, the MP-QUIC-based steering may include support for all three of MPQUIC-UDP, MPQUIC-IP, and MPQUIC-E. This differs from the baseline RG behavior in that the RG advertises enhanced transport-layer steering capabilities (i.e., MP-QUIC steering functionality) rather than only ATSSS-LL or MPTCP steering support. For example, the RG 920 may send a PDU Session Establishment/Modification Request message to an AMF 930. In an example, the PDU Session Establishment/Modification Request message includes not only a multi-access PDU (MA-PDU) request and ATSSS capabilities support information, but the ATSSS capabilities information will include information regarding. Additionally or alternatively, the PDU Session Establishment/Modification Request message may be sent to the AMF 930 by way of a (R)AN node 903.

Steps 2-6 in examples in FIG. 9 may be performed as in steps 2-6 in 3GPP TS 23.502, clause 4.3.2.2.1 involving the RG 920, the AMF 930, an SMF 940 and a unified data management (UDM) function 970, and may include SMF selection, PDU Session context creation, and PDU Session authorization. The contents of 3GPP TS 23.502 are incorporated herein by reference.

In step 7, the SMF 940 interacts with a PCF 950 to obtain ATSSS policies applicable to the RG 920, such as a session management (SM) policy which includes ATSSS capabilities. In contrast to standard ATSSS procedures, the policy information explicitly includes MP-QUIC-specific steering functionality parameters, such as one or more of: eligibility of flows for MP-QUIC, preferred access combinations (3GPP and non-3GPP), and path usage constraints. For example, the SMF 940 sends an SM policy request message, which includes MP-QUIC-specific steering functionality parameters, to PCF 950. Then, the PCF 950 sends an SM policy response message, which includes MP-QUIC-specific steering functionality parameters, to the SMF 940.

In step 8, the SMF 940 selects a UPF. For selecting the UPF, the SMF 940 includes the ATSSS MPQUIC steering functionality in the NFDiscovery_Request service operation to the network repository function (NRF) (NRF not shown).

In step 9, the SMF 940 interacts with the UPF 960 regarding N4 rules. The N4 rules are user plane rules, in an example. In examples provided herein, the messages regarding N4 rules may include information regarding MPQUIC steering functionality for the RG. For example, the SMF 940 sends an N4 Session Establishment/Modification Request to the UPF 960. If the MPQUIC-UDP and/or MPQUIC-IP functionalities are supported for the MA PDU Session with IP PDU Session type, the SMF 940 may instruct the UPF 960 to activate the corresponding functionality/functionalities for this MA PDU Session. If the MPQUIC-E functionality is supported for the MA PDU Session with Ethernet PDU Session type, the SMF 940 may instruct the UPF 960 to activate the MPQUIC-E functionality for this MA PDU Session.

If the message from the SMF 940 instructs the UPF 960 to activate MPQUIC-UDP and/or MPQUIC-IP or MPQUIC-E steering functionality, the UPF 960 allocates the RG "MPQUIC link-specific multipath" addresses/prefixes. The UPF 960 sends the "MPQUIC link-specific multipath" addresses/prefixes and MPQUIC proxy information that corresponds to the activated MPQUIC-based steering functionality/functionalities to the SMF 940.

Additionally, in step 10, the SMF 940 sends an Namf_Communication_N1N2MessageTransfer message, which includes information regarding MPQUIC steering functionality for the RG, to the AMF 930. In turn, the AMF 930 forwards the Namf_Communication_N1N2MessageTransfer message, including the information regarding MPQUIC steering functionality for the RG, to the (R)AN node 903. In an example, if the PDU Session Type is Ethernet, then, if the Steering functionality parameter in the MA PDU Session control information of the received PCC rule(s) is set only to MPQUIC-E, then SMF 940 provides the PDU Session type as IPv4, IPv6 or IPv4v6 in the N2 SM information to the (R)AN node 903. When only MPQUIC-E functionality is enabled for an MA PDU Session, the packets exchanged between RG 920 and UPF 960 are IP packets of the "MPQUIC link-specific multipath" addresses/prefixes (e.g.,, when the (R)AN node 903 transports IP packets between RG 920 and UPF 960). As described in clause 5.32.6.2.2 of 3GPP TS 23.501, PDU Session type IPv4, IPv6 or IPv4v6 is provided to the (R)AN node 903 so that the NG-RAN can apply robust header compression (ROHC). The contents of 3GPP TS 23.501 are incorporated herein by reference.

In step 11, the RG 920 receives a PDU Session Establishment/Modification Accept message from the (R)AN node 903, which indicates to the RG 920 that the requested MA PDU session was successfully established. This message includes the ATSSS rules for the MA PDU session, which were derived by SMF 940. If the MPQUIC-IP and/or MPQUIC-UDP or MPQUIC-E functionality/functionalities is supported for the MA PDU Session, the SMF 940 shall include the "MPQUIC link-specific multipath" addresses/prefixes of the RG 920 and the MPQUIC proxy information that corresponds to the activated MPQUIC-based steering functionality/functionalities. As a result, the RG 920 may then use one or more IP addresses assigned by the SMF 940, which may be one or more of the six IP addresses noted above (IP@1 through IP@6), and the activated MPQUIC-based steering functionality/functionalities in order to access the network.

The main deviation from the baseline is that transport-layer multipath decisions are executed at the RG 920 using MP-QUIC logic, rather than relying on lower-layer steering or end-host MPTCP.

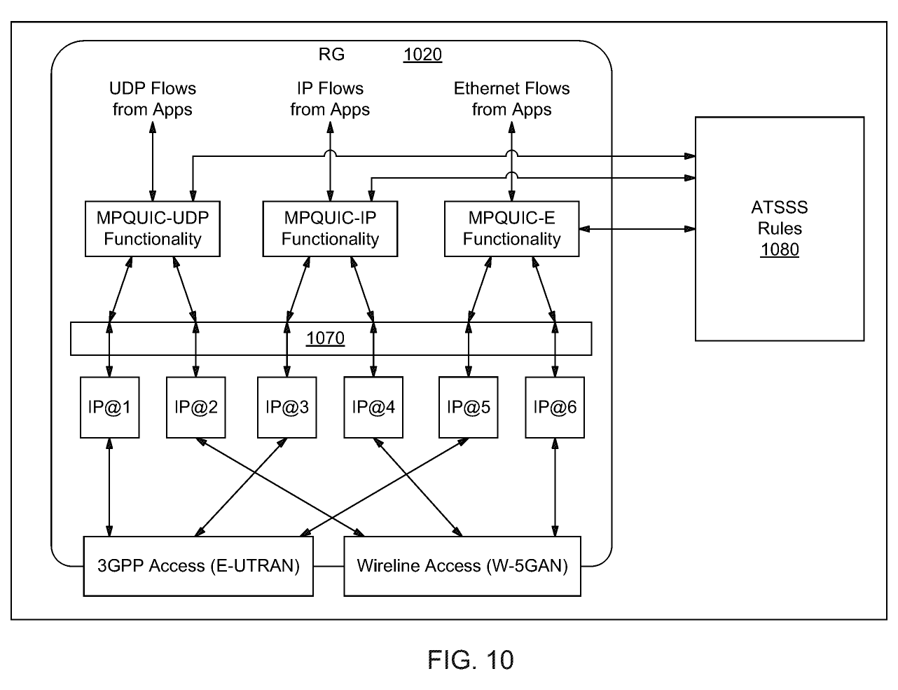

FIG. 10 illustrates an example of architecture for supporting MPQUIC-based ATSSS steering functionalities within an RG for access over an E-UTRAN and W-5GAN. In examples in FIG. 10, for an RG 1020, an MA PDU Session may use user-plane resources of an associated packet data network (PDN) Connection on 3GPP access in an evolved packet core (EPC). This enables a scenario where an MA PDU Session can simultaneously be associated with user-plane resources on a 3GPP access network connected to the EPC and a W-5GAN connected to a 5GC. Such a PDN Connection in an evolved packet system EPS would thus be associated with multi-access capability in the RG and in a PDN gateway-control plane+SMF (PGW-C+SMF).

When the RG 1020 requests establishment of a new PDN Connection when the RG 1020 is registered via 3GPP access in the EPS using the PDN Connection Establishment procedure, the RG 1020 provides, via protocol configuration options (PCO), to the PGW-C+SMF the RG's ATSSS capabilities which may include MPQUIC-UDP/MPQUIC-IP/MPQUIC-E steering functionalities.

The ATSSS 1080 rules are provided from the PGW-C+SMF to the RG 1020 via SM NAS signaling over the 5GC. ATSSS 1080 rules may also be provided via the EPC. The PGW-C+SMF provides the following information in the PCO to the RG 1020: If the RG 1020 has indicated that it is capable of supporting the MPQUIC-UDP functionality and/or MPQUIC-IP functionality or MPQUIC-E functionality, and the PGW-C+SMF accepts to activate the MPQUIC-UDP functionality and/or MPQUIC-IP functionality or MPQUIC-E functionality, then the network provides MPQUIC proxy information corresponding to the activated MPQUIC-based steering functionality/functionalities to the RG 1020.

Depending on the RAT types supported by the RG 1020, the PDN connection may also be handed over to 3GPP access in the 5GC. For an RG supporting both E-UTRAN/EPC access and NG-RAN/5GC access, the user plane resources for 3GPP access may be moved between E-UTRAN/EPC access and NG-RAN/5GC access. The PDU Session and User Plane resources active over non-3GPP/5GC access are not affected by such an inter-3GPP access RAT change.

As in the examples shown in FIG. 8, in the examples shown in FIG. 10, the RG 1020 supports multiple MPQUIC steering instantiations: MPQUIC-UDP functionality when an MA PDU Session type is IPv4, IPv6, or IPv4v6, MPQUIC-IP functionality when the MA PDU Session type is IPv4, IPv6, or IPv4v6, and MPQUIC-Ethernet functionality when the MA PDU Session type is Ethernet. Each of these functional blocks represents a distinct steering mode in which the RG 1020 encapsulates or maps incoming traffic into MPQUIC connections suitable for multipath operation.

Below the MPQUIC functional blocks, the example in FIG. 10 shows a common steering and forwarding layer 1070 that manages multiple IP anchor points or addresses (labeled IP@1 through IP@6). These IP addresses represent different logical paths or interfaces that can be bound to either a 3GPP E-UTRAN/EPC or a non-3GPP wireline access (Wireline 5G Access Network (W-5GAN)).

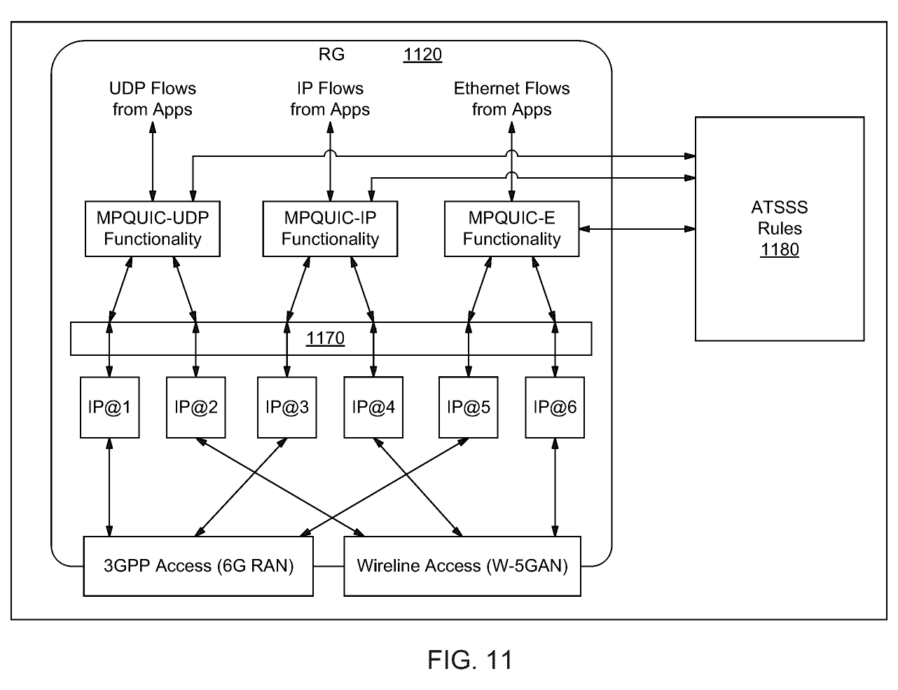

FIG. 11 illustrates an example of architecture for supporting MPQUIC-based ATSSS steering functionalities within an RG for access over a 6G RAN and W-5GAN. In examples in FIG. 11, similar to the examples in FIGS. 8 and 10, traffic from applications for an RG 1120 can be handled and distributed across multiple accesses under network-provided ATSSS rules 1180. In an example, the ATSSS rules 1180 are provided from an SMF to the RG 1120 via SM NAS signaling over a W-5GAN. Additionally or alternatively, the ATSSS rules 1180 are provided from a 6G SMF to the RG 1120 via SM NAS signaling over a 6G RAN. Further, in an example, the RG may be a 6G RG.

As in the examples shown in FIGS. 8 and 10, in the examples shown in FIG. 11, the RG 1120 supports multiple MPQUIC steering instantiations: MPQUIC-UDP functionality when an MA PDU Session type is IPv4, IPv6, or IPv4v6, MPQUIC-IP functionality when the MA PDU Session type is IPv4, IPv6, or IPv4v6, and MPQUIC-Ethernet functionality when the MA PDU Session type is Ethernet. Each of these functional blocks represents a distinct steering mode in which the RG 1120 encapsulates or maps incoming traffic into MPQUIC connections suitable for multipath operation.

Below the MPQUIC functional blocks, the example in FIG. 11 shows a common steering and forwarding layer 1170 that manages multiple IP anchor points or addresses (labeled IP@1 through IP@6). These IP addresses represent different logical paths or interfaces that can be bound to either a 3GPP 6G RAN or a non-3GPP wireline access (Wireline 5G Access Network (W-5GAN)).

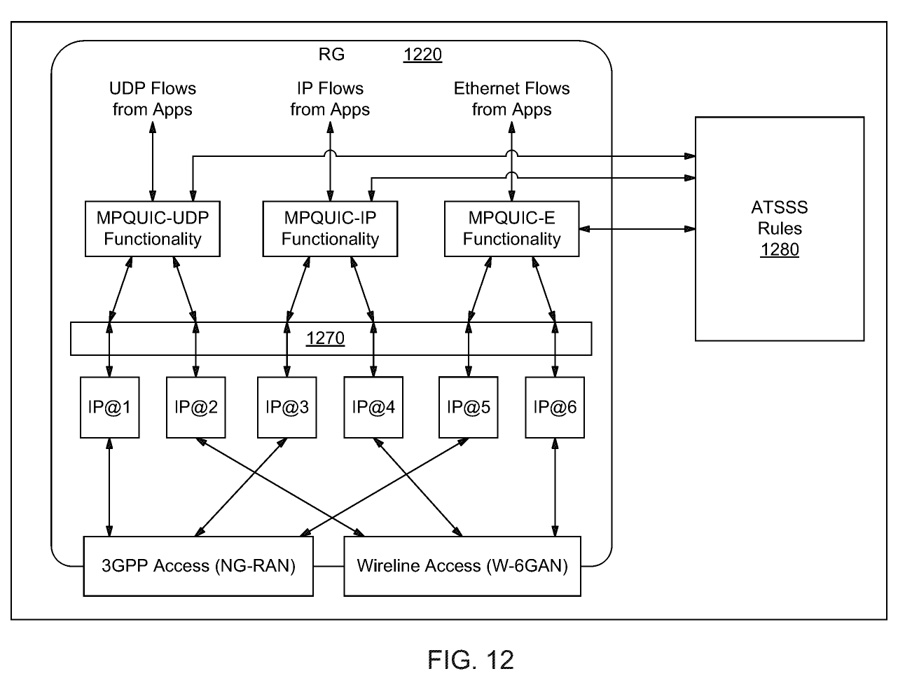

FIG. 12 illustrates an example of architecture for supporting MPQUIC-based ATSSS steering functionalities within an RG for access over an NG-RAN and wireline 6G-access network (W-6GAN). In examples in FIG. 12, similar to the examples in FIGS. 8, 10 and 11, traffic from applications for an RG 1220 can be handled and distributed across multiple accesses under network-provided ATSSS rules 1280. In an example, the ATSSS rules 1280 are provided from an SMF to the RG 1220 via SM NAS signaling over the NG-RAN. Additionally or alternatively, the ATSSS rules 1180 are provided from a 6G SMF to the RG 1120 via SM signaling over W-6GAN. Further, in an example, the RG may be a 6G RG.

As in the examples shown in FIGS. 8, 10 and 11, in the examples shown in FIG. 12, the RG 1220 supports multiple MPQUIC steering instantiations: MPQUIC-UDP functionality when an MA PDU Session type is IPv4, IPv6, or IPv4v6, MPQUIC-IP functionality when the MA PDU Session type is IPv4, IPv6, or IPv4v6, and MPQUIC-Ethernet functionality when the MA PDU Session type is Ethernet. Each of these functional blocks represents a distinct steering mode in which the RG 1220 encapsulates or maps incoming traffic into MPQUIC connections suitable for multipath operation.

Below the MPQUIC functional blocks, the example in FIG. 12 shows a common steering and forwarding layer 1270 that manages multiple IP anchor points or addresses (labeled IP@1 through IP@6). These IP addresses represent different logical paths or interfaces that can be bound to either a 3GPP NG RAN or a non-3GPP wireline access (Wireline 6G Access Network (W-6GAN)).

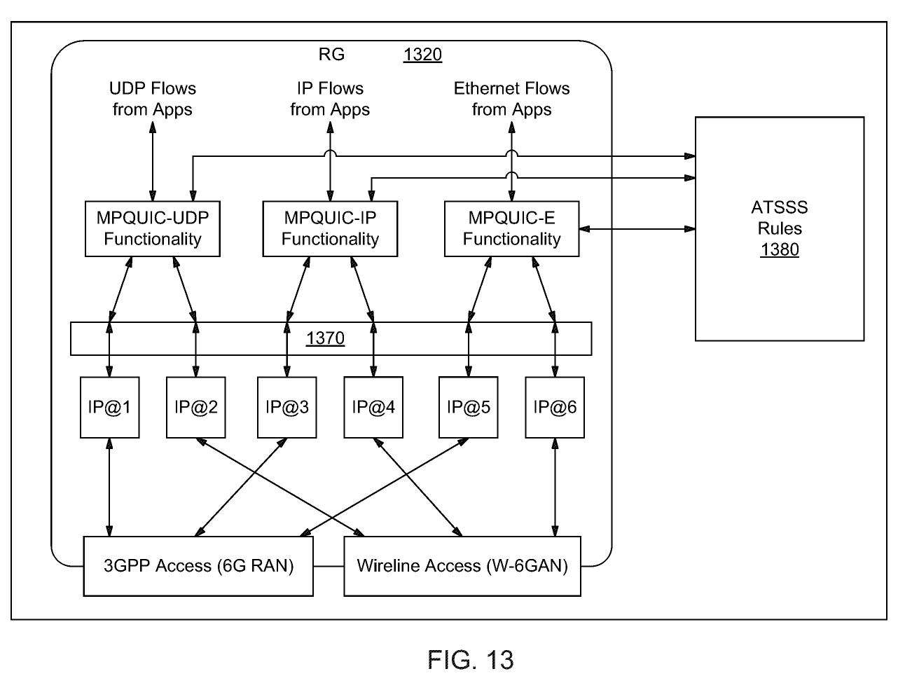

FIG. 13 illustrates an example of architecture for supporting MPQUIC-based ATSSS steering functionalities within an RG for access over an 6G-RAN and W-6GAN. In examples in FIG. 13, similar to the examples in FIGS. 8 and 10 through 12, traffic from applications for an RG 1320 can be handled and distributed across multiple accesses under network-provided ATSSS rules 1380. In an example, the ATSSS rules 1380 are provided from a 6G SMF to the RG 1320 via SM NAS signaling over the 6G RAN. Additionally or alternatively, the ATSSS rules 1380 are provided from a 6G SMF to the RG 1320 via SM signaling over W-6GAN. Further, in an example, the RG may be a 6G RG.

As in the examples shown in FIGS. 8 and 10 through 12, in the examples shown in FIG. 13, the RG 1320 supports multiple MPQUIC steering instantiations: MPQUIC-UDP functionality when an MA PDU Session type is IPv4, IPv6, or IPv4v6, MPQUIC-IP functionality when the MA PDU Session type is IPv4, IPv6, or IPv4v6, and MPQUIC-Ethernet functionality when the MA PDU Session type is Ethernet. Each of these functional blocks represents a distinct steering mode in which the RG 1320 encapsulates or maps incoming traffic into MPQUIC connections suitable for multipath operation.

Below the MPQUIC functional blocks, the example in FIG. 13 shows a common steering and forwarding layer 1370 that manages multiple IP anchor points or addresses (labeled IP@1 through IP@6). These IP addresses represent different logical paths or interfaces that can be bound to either a 3GPP 6G RAN or a non-3GPP wireline access (Wireline 6G Access Network (W-6GAN)).

In an example, an RG sends, to a network node, a PDU session request message for an MA PDU session. The PDU session request message includes information indicating RG support for ATSSS. Further, the information indicating RG support for ATSSS includes information indicating RG support for MPQUIC. The RG receives a PDU session response message, including ATSSS rules for the MA PDU session and MPQUIC link-specific multipath addresses of the RG. The determines a network access for the MA PDU session from one of a first network access or a second network access. Moreover, the RG transmits and receives data over the determined network access for the MA PDU session based on the MPQUIC link-specific multipath addresses of the RG.

Additionally or alternatively, the information indicating RG support for MPQUIC includes information indicating RG support for MPQUIC-UDP. Additionally or alternatively, the information indicating RG support for MPQUIC includes information indicating RG support for MPQUIC-IP. Additionally or alternatively, the information indicating RG support for MPQUIC includes information indicating RG support for MPQUIC-E.

Additionally or alternatively, the PDU session request message is a PDU session establishment request message. Additionally or alternatively, the PDU session response message is a PDU session establishment accept message.

Additionally or alternatively, the PDU session request message is a PDU session modification request message. Additionally or alternatively, the PDU session response message is a PDU session modification acknowledgement/command message.

Additionally or alternatively, the RG activates MPQUIC-based steering functionality for the RG. Additionally or alternatively, the PDU session response message is a PDU session establishment/modification response message. Additionally or alternatively, the PDU session establishment/modification response message further includes MPQUIC proxy information corresponding to the activated MPQUIC-based steering functionality for the RG. Additionally or alternatively, wherein the data is transmitted and received using the activated MPQUIC-based steering functionality for the RG.

Additionally or alternatively, the first network access is a cellular network access. Additionally or alternatively, the second network access is a Wi-Fi network access.

Additionally or alternatively, the MPQUIC link-specific multipath addresses of the RG are received from an SMF, via an AMF. Additionally or alternatively, the MPQUIC link-specific multipath addresses of the RG are received from an access network (AN) node.

Additionally or alternatively, the network access for the MA PDU session is determined using MP-QUIC logic. Additionally or alternatively, the MA PDU session response message includes MPQUIC steering information.

Additionally or alternatively, a PDU session type, for the MA PDU session, is IPv4. Additionally or alternatively, a PDU session type, for the MA PDU session, is IPv6. Additionally or alternatively, a PDU session type, for the MA PDU session, is IPv4v6. Additionally or alternatively, a PDU session type, for the MA PDU session, is Ethernet.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a UE, terminal, base station, RNC, or any host computer.

What is claimed:

1. A residential gateway (RG) comprising:
a processor; and
a communications interface operatively coupled to the processor; wherein:
the processor and the communications interface are configured to send, to a network node, a protocol data unit (PDU) session request message for a multi-access (MA) PDU session, wherein the PDU session request message includes information indicating RG support for Access Traffic Steering, Switching, and Splitting (ATSSS), wherein the information indicating RG support for ATSSS includes information indicating RG support for multipath QUIC (MPQUIC);
the communications interface is configured to receive a PDU session response message, including ATSSS rules for the MA PDU session and MPQUIC link-specific multipath addresses of the RG;
the processor is configured to determine a network access for the MA PDU session from one of a first network access or a second network access; and
the processor and the communications interface are configured to transmit and receive data over the determined network access for the MA PDU session based on the MPQUIC link-specific multipath addresses of the RG.

2. The RG of claim 1, wherein the information indicating RG support for MPQUIC includes information indicating RG support for one or more of: MPQUIC-user datagram protocol (UDP), MPQUIC-internet protocol (IP), or MPQUIC-Ethernet (MPQUIC-E).

3. The RG of claim 1, wherein the PDU session request message is a PDU session establishment request message, and the PDU session response message is a PDU session establishment accept message.

4. The RG of claim 1, wherein the PDU session request message is a PDU session modification request message, and the PDU session response message is a PDU session modification acknowledgement/command message.

5. The RG of claim 1, wherein the processor and the communications interface are further configured to activate MPQUIC-based steering functionality for the RG, wherein the PDU session response message is a PDU session establishment/modification response message, and the PDU session establishment/modification response message further includes MPQUIC proxy information corresponding to the activated MPQUIC-based steering functionality for the RG, and wherein the data is transmitted and received using the activated MPQUIC-based steering functionality for the RG.

6. The RG of claim 1, wherein the first network access is a cellular network access, and the second network access is a Wi-Fi network access.

7. The RG of claim 1, wherein the MPQUIC link-specific multipath addresses of the RG are received from a session management function (SMF), via an access and mobility management function (AMF), and an access network (AN) node.

8. The RG of claim 1, wherein the network access for the MA PDU session is determined using MP-QUIC logic, and wherein the RG is a Fifth Generation (5G)-RG.

9. The RG of claim 1, wherein the PDU session response message includes MPQUIC steering information.

10. The RG of claim 1, wherein a PDU session type, for the MA PDU session, is one of IPv4, IPv6, IPv4v6 or Ethernet.

11. A method in a residential gateway (RG), the method comprising:
sending, to a network node, a protocol data unit (PDU) session request message for a multi-access (MA) PDU session, wherein the PDU session request message includes information indicating RG support for Access Traffic Steering, Switching, and Splitting (ATSSS), wherein the information indicating RG support for ATSSS includes information indicating RG support for multipath QUIC (MPQUIC);
receiving a PDU session response message, including ATSSS rules for the MA PDU session and MPQUIC link-specific multipath addresses of the RG;
determining a network access for the MA PDU session from one of a first network access or a second network access; and
transmitting and receiving data over the determined network access for the MA PDU session based on the MPQUIC link-specific multipath addresses of the RG.

12. The method of claim 11, wherein the information indicating RG support for MPQUIC includes information indicating RG support for one or more of: MPQUIC-user datagram protocol (UDP), MPQUIC-internet protocol (IP), or MPQUIC-Ethernet (MPQUIC-E).

13. The method of claim 11, wherein the PDU session request message is a PDU session establishment request message, and the PDU session response message is a PDU session establishment accept message.

14. The method of claim 11, wherein the PDU session request message is a PDU session modification request message, and the PDU session response message is a PDU session modification acknowledgement/command message.

15. The method of claim 11, further comprising:
activating MPQUIC-based steering functionality for the RG, wherein the PDU session response message is a PDU session establishment/modification response message, and the PDU session establishment/modification response message further includes MPQUIC proxy information corresponding to the activated MPQUIC-based steering functionality for the RG, and wherein the data is transmitted and received using the activated MPQUIC-based steering functionality for the RG.

16. The method of claim 11, wherein the first network access is a cellular network access, and the second network access is a Wi-Fi network access.

17. The method of claim 11, wherein the MPQUIC link-specific multipath addresses of the RG are received from a session management function (SMF), via an access and mobility management function (AMF), and an access network (AN) node.

18. The method of claim 11, wherein the network access for the MA PDU session is determined using MP-QUIC logic, and wherein the RG is a Fifth Generation (5G)-RG.

19. The method of claim 11, wherein the PDU session response message includes MPQUIC steering information.

20. The method of claim 11, wherein a PDU session type, for the MA PDU session, is one of IPv4, IPv6, IPv4v6 or Ethernet.
